(19) United States
(12) Patent Application Publication
(10) Pub. No.: US 2010/0325088 A1
(43) Pub. Date: Dec. 23, 2010

(54) 12-LEAD ECG AND IMAGE TELECONSULTATION INFORMATION SYSTEM

(75) Inventors: Jui-Chien Hsieh, Taoyaun (TW); Hsiu-Chiung Lo, Taoyaun (TW)

Correspondence Address: WPAT, PC;INTELLECTUAL PROPERTY ATTORNEYS, 2030 MAIN STREET, SUITE 1300, IRVINE, CA, 92614, US

(73) Assignee: YUAN ZE UNIVERSITY, TAOYAUN (TW)

(21) Appl. No.: 12/647,311

(22) Filed: Dec. 24, 2009

(30) Foreign Application Priority Data
Jun. 23, 2009 (TW) 098120942

(51) Int. Cl. G06F 17/30

(52) U.S. Cl. 707/610; 707/769; 707/E17.005; 707/802; 707/705; 707/E17.014

(57) ABSTRACT

The present invention provides a 12-lead ECG and image teleconsultation system for processing clinical 12-lead ECG, the said system comprising: (a) a PACS having built-in database A for accessing, transmitting and displaying image to a gateway server; (b) a gateway server having built-in database B corresponding to database A in order to access database C attached to a remote controlthe remote control; and (c) a remote control having built-in database C providing for users inquiring in database A through database B and browsing or editing medical image and clinical 12-lead ECG to access databases A and B.

### FIELD OF THE INVENTION

The present invention relates to an information system for clinical 12-lead electrocardiogram (ECG) and image teleconsultation.

### BACKGROUND OF THE INVENTION

The Digital Imaging and Communications in Medicine (DICOM) (3.0) is set up for medical image communicating and exchanging in open-type in order to keep compatibility with different brands, models, and file formats. The clinical instruments often use DICOM to save files such as computer tomography (CT), magnetic resonance imaging (MRI), chest or orthopaedic radiography, and fluorescein angiography (FA) according to DICOM 3.0. The Picture Archiving and Communication Systems (PACS) in medical facility are used for saving DICOM files. The main objects of PACS are to save all images as digital type and to transfer the data to the system by internet for users diagnosing at distal end.

The Clinical 12-lead electrocardiogram (ECG) is a very important tool which is normalized by DICOM 3.0 supplemental document in clinical cardiology. That supplemental document provides a standard of one-dimensional biomedical signal such as blood pressure or ECG However, medical instrument companies do not obey standard file formats. On the contrary, they make self-research out of standard. For example, the file formats are HP SCP-ECG and PHILIPS XML-ECG The drawbacks are on not only integrating various formats difficultly but also sharing data inconveniently.

According to prior art, many hospitals progressively treat patients and read examination reports by computers as the improvement of medical charts transformed into electronic files. Nevertheless, conducting tasks described as above must take advantage of personal computer (PC) provided by hospitals to access and read medical information as disclosed in Taiwan patents or publications No. 1229281, 1228375, 588274, 200422908, and 200423645. Besides, Taiwan publications No. 200844849 and 200806251 could make it by PC at distal end, but they lack mobility.

To satisfy the need of telemedicine and mobility, Mobile DICOM server (MDS) could be used with a remote control (e.g. PDA) to download and read data. The disadvantage is that sharing data with a remote control (e.g. PDA) is after DICOM server exchange data with PACS. Moreover, DICOM server is a commercial and technical merchandise so that it is monopolized easily. Hospitals could not extend and develop needful functions by themselves (Nakata N. et. al. (1999) International Congress Series 1268, 260-264).

In addition, PACS could share medical information directly and read DICOM image files via remote control, but the compatible file types are not many (Andrade R et. al. (2003) International Journal of Medical Informatics 71, 157-163). The disadvantage is that integrating 12-lead ECG DICOM files used in clinical cardiology is hard so that it couldn't be used for telemedicine.

### BRIEF DESCRIPTION OF THE DRAWINGS

FIG. 1 shows a systemic architecture of the present invention.

FIG. 2 shows database architecture of PACS.

FIG. 3 shows flowcharts of data inquiring and format conversion between heterogeneous databases.

FIG. 4 shows a flowchart of DICOM files accessing.

FIG. 5 shows an appearance of search results.

FIG. 6 shows a function interface.

FIG. 7 shows the clinical 12-Lead ECG

FIG. 8 shows an MRI result.

FIG. 9 shows a written report.

FIG. 10 shows a DICOM Tag browsing screen.

### SUMMARY OF THE INVENTION

The present invention provides an information system for clinical 12-lead ECG and image teleconsultation system, the said system comprising: (a) a PACS having built-in database A for accessing, transmitting and displaying image to a gateway server; (b) a gateway server having built-in database B corresponding to database A in order to access database C attached to a remote controlthe remote control; and (c) a remote control having built-in database C providing for users inquiring in database A through database B and browsing or editing medical image and clinical 12-lead ECG to access databases A and B.

### DETAILED DESCRIPTION OF THE INVENTION

The present invention relates to an information system for clinical 12-lead ECG and image teleconsultation. The invention provides a clinical physician in emergency department not only to conduct real-time online browsing DICOM medical images and clinical 12-lead ECG through a remote control (e.g. PDA) but also to perform remote diagnosis and edit the reports. Telemedicine without restriction on PC by medical doctors can be realized. Physicians at a distance can take advantage of wireless internet or 3.5 G communication to inquire and browse patients' information through the remote control in order to diagnose patients, and then transmit diagnostic reports to the database in the hospital to update data simultaneously. The present invention provides real-time and precise telemedical service. Main merits of the invention are as follows:

1. 12-lead ECG and chest radiography are important reference to clinical emergency treatment.

2. 12-lead ECG is a waveform type of one-dimensional time series data. However, most clinical storage formats are SCP-ECG and XML-ECG As to chest radiography, an image type of two-dimensional data, the clinical storage type is DICOM format.

3. Integration between waveform types and image types and between different systems are required to facilitate healthcare providers to process data and simplify system maintenance performed by engineers.

4. For the telemedicine in emergency cardiology, immediate transmission of images and the 12-lead ECG to cardiologist out of the hospital are required.

At present, cardiology department needs DICOM-formatted chest radiographs and 12-lead ECG in DICOM formats which are different from the DICOM image technology applied to clinical neurosurgery, radiology, dermatology and opthalmology. Comparatively, the present invention has features as follows:

1. Information integration.

2. System integration.

3. Transmission of ECG and image.

4. Application to emergency cardiology in clinical.

The present invention integrates 12-lead ECG system (DICOM-ECG) into PACS. It makes 12-lead ECG in waveform having ability to access and transmit image files. Furthermore, the invention can transmit medical image files and ECG together to physicians' cell phones at a distance in order to make a remote diagnosis effectively.

The main feature of the present invention is that the remote control can browse all images such as clinical 12-lead ECG and medical DICOM images, e.g. computer tomography (CT), ultrasound (US) imaging, and magnetic resonance imaging (MRI) from different medical system in the same user interface anywhere. Physicians can browse medical images and write reports in the same system which manages information conveniently and has the ability of remote diagnosis.

The present invention relates to a 12-lead ECG and image teleconsultation system for processing clinical 12-lead ECG, the said system comprising: a PACS having built-in database A (MySQL) for accessing, receiving, transmitting and displaying image to a gateway server; a gateway server having built-in database B (Microsoft SQL) corresponding to database A in order to access database C (mobile database) attached to a remote control; and a remote control having built-in database C providing for users inquiring in database A through database B, and browsing or editing what are medical images and clinical 12-lead ECG, and further to access databases A and B.

The database A comprises: a patient information table having personal information and several optional study information tables; a study information table having study information and several optional series tables; a series information table having series information and several optional image information tables; an image information table having image information and several optional DICOM file tables; and a DICOM file table having several DICOM files including without limitation to clinical 12-lead ECG, CT, US and MRI.

The remote control comprises: a systemic browser for users to inquire or browse patients' information in the database C and further to edit reports; Database C synchronized with database B by internet in order to access or edit database A or C; and a device for processing DICOM files, corresponding to systemic browser to browse and access the DICOM files and further to integrate the said reports into the said DICOM files. The said reports in the said device for processing DICOM files comprise editing steps of:
(a) confirming whether a file is a DICOM header to identify whether the file is a DICOM file;
(b) reading DICOM Tag to acquire DICOM image according to definition of DICOM tag model from DICOM 3.0 standard;
(c) writing the DICOM header and acquiring the said patients' information and the information of the said DICOM tag to integrate with users' written reports into reports and the said DICOM tag; and
(d) repackaging DICOM files to save to database A through synchronizing database B.

The said device for processing DICOM files further provides image setting function comprising: a function for opening, reading Tag and storing DICOM files; a function for zooming in/out, resetting and moving picture; a function for switching single or group pictures; and a function for adjusting brightness and contrast.

The interaction between the gateway server and the remote control comprises the steps of:
(a) receiving inquiry command about requirement and conditions from the said remote control;
(b) inquiring PACS about whether database A has the data matching inquiry conditions;
(c) the said remote control reading the related data from database A while database A having the matched data; on the contrary, the said remote control getting response “No Data” from database A;
(d) converting data format in order to save data into database B if data exchange involved in heterogeneous databases while database A delivering the related data to database B;
(e) responding to the remote control to access data; and
(f) the database C of the said remote control synchronizing with database B by internet.

The interaction further provides that users edit the data in database C of the remote control and then save it in database A via synchronizing database B. The said remote control is a personal computer, a notebook, a personal digital assistant (PDA), or a cell phone.

### EXAMPLE

The examples below are non-limiting and are merely representative of various aspects and features of the present invention.

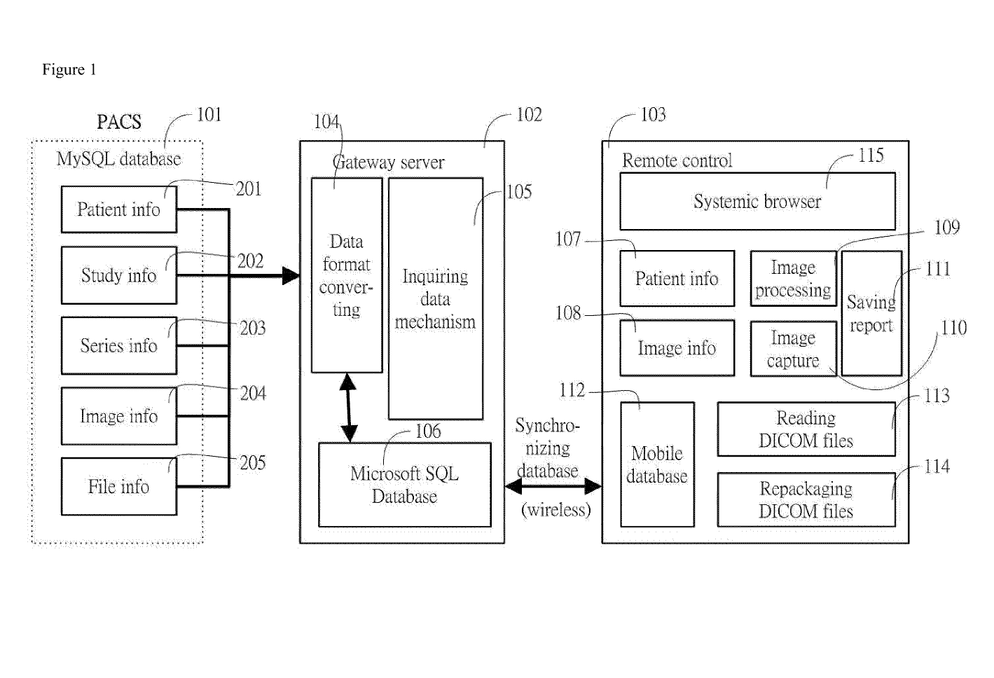

As shown in FIG. 1, the present invention related to an information system for clinical 12-lead ECG and image teleconsultation. The invention converted 104 data format from MySQL database 101 of the PACS to Microsoft SQL 106 of the gateway server 102. After data inquiry mechanism 105, the invention made mobile database 112 of the remote control 103 access data from MySQL database and then took advantage of steps such as reading files 113, image processing 109 and image capture 110 with patients' information 107 and image information 108 to display in systemic browser 115 in the remote control. Besides, users wrote, saved reports 111 and then repackaged DICOM files 114 in order to transmit the files to the hospital PACS via the remote control. The present invention was compatible with information system. Following is an preferred embodiment described in details.

### MySQL of the PACS:

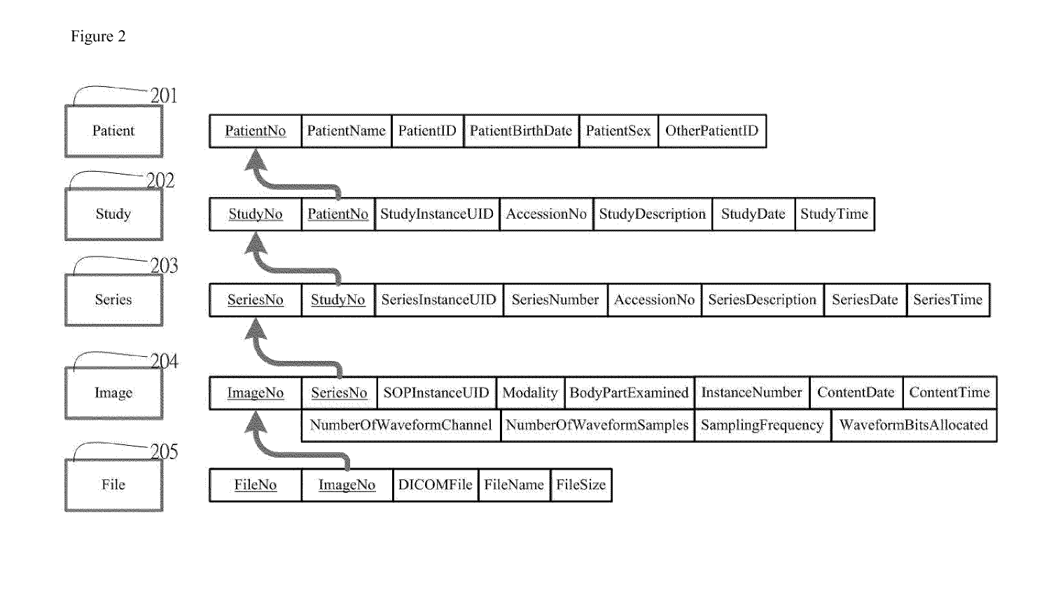

The database of the PACS was MySQL 101. As shown in FIG. 2, the hospital database of the PACS searched for related information in DICOM Tag in order to establish the relationship between DICOM files. Patients' information 201 had several study information 202. A study information had several series information 203. A series information had several image information 204. In general, an image was displayed in a DICOM file (file info) 205.

### Data Inquiry Mechanism and Conversion Between Heterogeneous Databases:

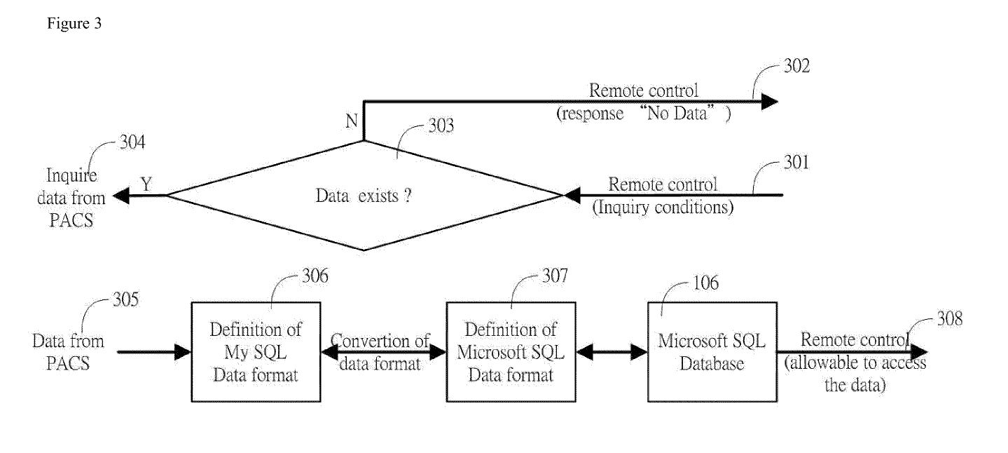

As shown in FIG. 3, the remote control sent inquiry 301 to the gateway server and transmitted inquiry commands and inquiry conditions. After the gateway server receiving inquiry commands, it searched the MySQL of the PACS for matched data 303. If there was a result, the gateway server inquired the related data from PACS 304. Oppositely, the gateway serer responded “No Data” 302 to the remote control.

When the PACS transmitted data into gateway server 305, data format was defined by MySQL 306. However, the data format in Microsoft SQL 307 of the gateway server was not compatible with the said data from the PACS. If data transmission between heterogeneous databases were required, conversion of data formats were necessary. For the same reason, the Microsoft SQL saved the data 106 in the gateway server and responded the message “accessible” to the remote control 308 through converting data format of MySQL to Microsoft SQL.

### Accessing DICOM Files:

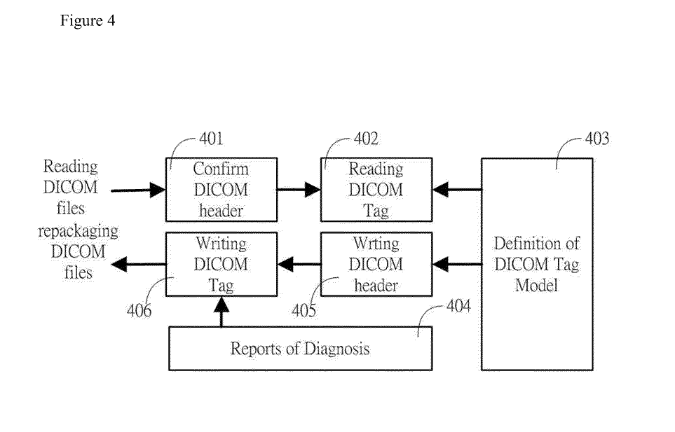

When the remote control received signals of permission to access the data, the database of the said remote control would synchronize with the database of the gateway server. After synchronizing, the remote control had patients' information, study information, file information and the DICOM files. Since images were saved in the DICOM files, DICOM files had to be read in order to read the images. As shown in FIG. 4, the method to confirm whether a file was a DICOM file was to identify if the file had a DICOM header 401 at first. In the beginning of a DICOM file, 128 bits were provided for storing zero values and then 4 bits for saving four letters “DICM” in ASCII code so that 132 bits were for a DICOM header of a DICOM file in total. Continually, the remote control read the DICOM Tag 402 sequentially according to the definition of DICOM Tag model 403 in DICOM 3.0 standard.

Additionally, the reports written by physicians after diagnosis were transmitted to PACS in order to review easily in hospital system for physicians. In writing the DICOM header, the remote control integrated the reports of diagnosis 404 and the relevant tag data from previously readDICOM into the DICOM Tag and the data 405. Finally, the remote control repackaged the DICOM files 406, and then updated the PACS.

### User Interface of the Remote Control:

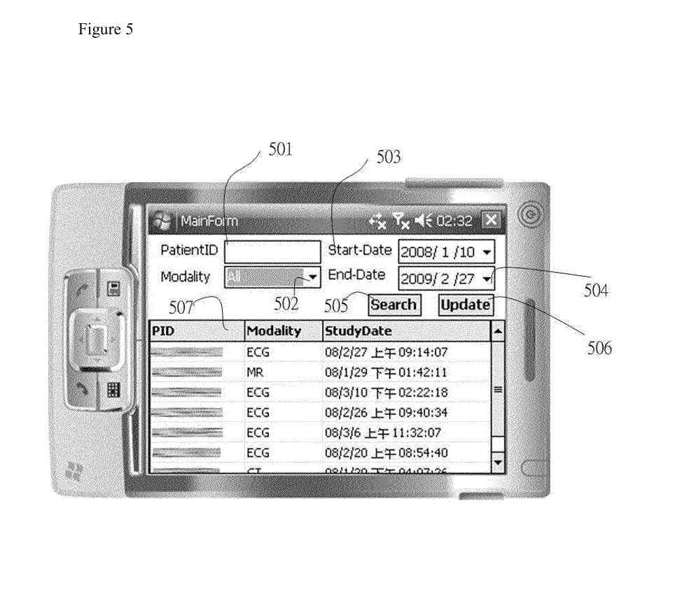

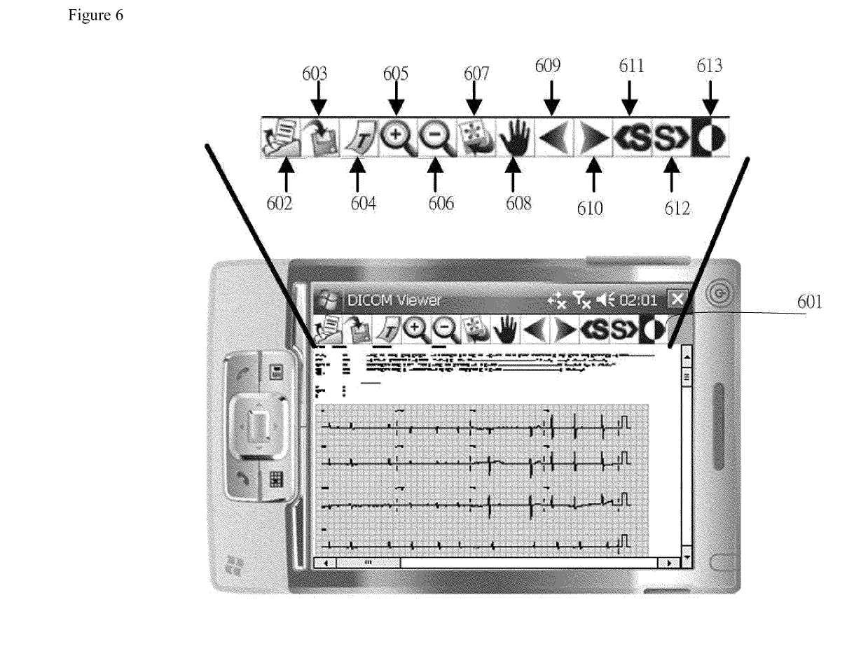

The user interface of the present invention is shown in FIG. 5. In inquiring, the users could input inquiry conditions such as patient ID 501, file modality 502, start-date 503 and end-date 504. Besides, the users could get the data shown in tables below the picture through searching 505 or updating 506 commands. When the users chose any data, the user interface would display the images of the data. As shown in FIG. 6, there were several functions such as image setting 601, opening file 602, saving file 603, reading Tag 604, zoom in 605, zoom out 606, picture resetting 607, moving picture 608, previous picture 609, next picture 610, previous series pictures 611, next series pictures 612, and adjusting contrast and brightness 613.

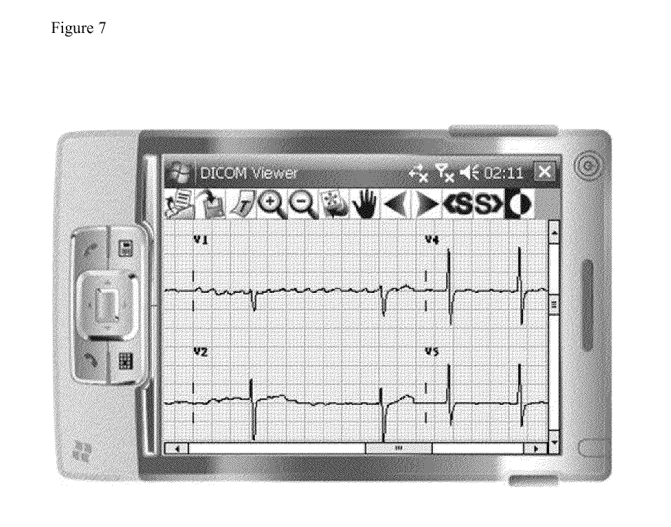

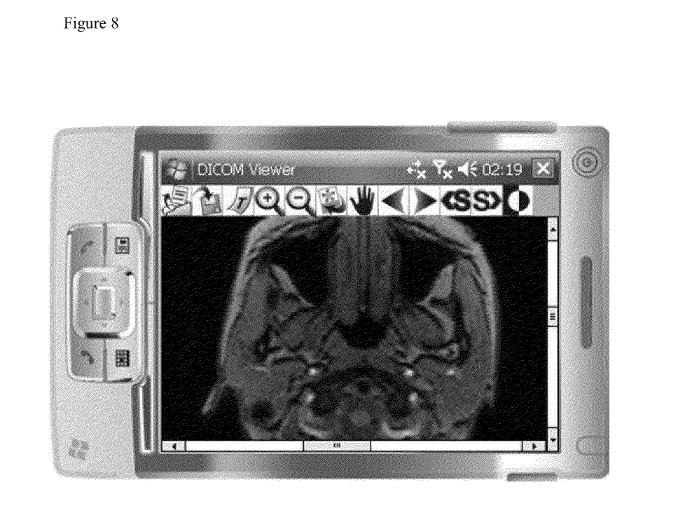

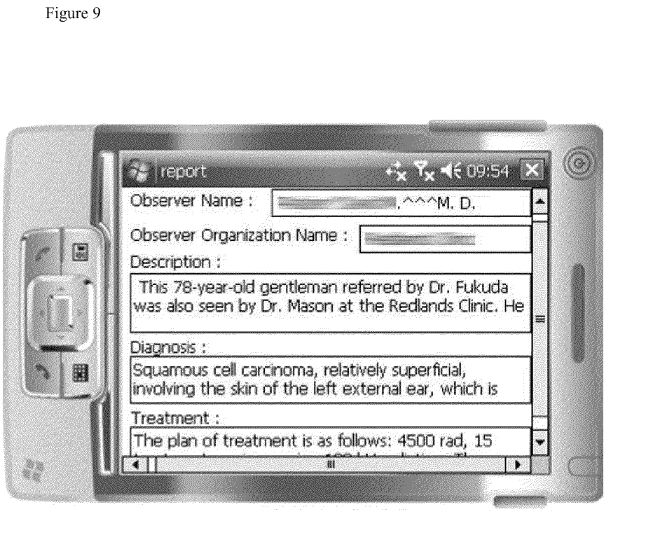

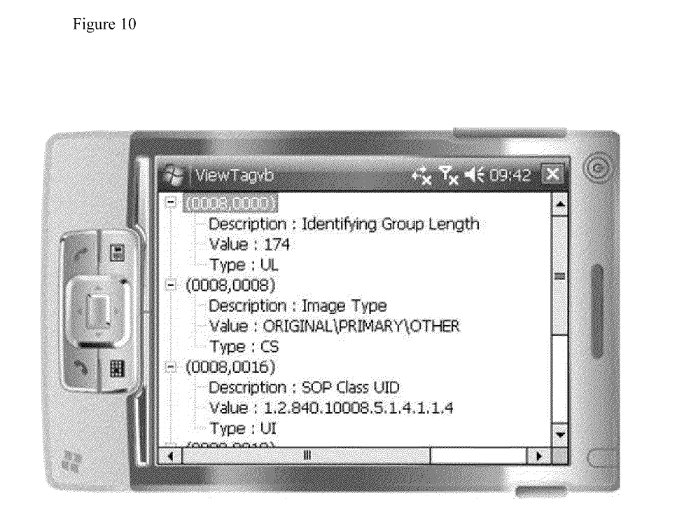

FIGS. 6 and 7 are clinical 12-lead ECG. FIG. 8 is an MRI result. FIG. 9 is a picture for the users diagnosing and writing the reports for patients. FIG. 10 is a picture for browsing DICOM Tag.

What is claimed is:

1. A 12-lead ECG and image teleconsultation system for processing clinical 12-lead ECG comprising:
(a) a PACS having built-in database A for accessing, receiving, transmitting and displaying image to a gateway server;
(b) a gateway server having built-in database B corresponding to database A in order to access database C attached to a remote control; and
(c) a remote control having built-in database C providing for users inquiring in database A through database B, and browsing or editing what are medical images and clinical 12-lead ECG, and further to access databases A and B.

2. The system of claim 1, wherein the remote control comprises:
(a) a systemic browser for users to inquire or browse patients' information in the database C and further to edit reports;
(b) Database C synchronized with database B by internet in order to access or edit database A or C; and
(c) a device for processing DICOM files, corresponding to systemic browser to browse and access the DICOM files and further to integrate the said reports into the said DICOM files.

3. The system of claim 2, wherein the device for processing DICOM files further provides image setting function comprising:
(a) a function for opening, reading Tag and storing DICOM files;
(b) a function for zooming in/out, reseting and moving picture;
(c) a function for switching single or group pictures; and
(d) a function for adjusting brightness and contrast.

4. The system of claim 1, wherein the database A comprises:
(a) a patient information table having personal information and several optional study information tables;
(b) a study information table having study information and several optional series tables;
(c) a series information table having series information and several optional image information tables;
(d) an image information table having image information and several optional DICOM file tables; and
(e) a DICOM file table having several DICOM files including clinical 12-lead ECG, CT, US and MRI.

5. The system of claim 1, wherein the interaction between the gateway server and the remote control comprises the steps of:
(a) receiving inquiry command about requirement and conditions from the said remote control;
(b) inquiring PACS about whether database A has the data matching inquiry conditions;
(c) the said remote control reading the related data from database A while database A having the matched data; on the contrary, the said remote control getting response “No Data” from database A;
(d) converting data format in order to save data into database B if data exchange involved in heterogeneous databases while database A delivering the related data to database B;
(e) responding to the remote control to access data; and
(f) the database C of the said remote control synchronizing with database B by internet.

6. The system of claim 5, wherein the interaction further provides that users edit the data in database C of the remote control and then save it in database A via synchronizing database B.

7. The system of claim 2, wherein the said reports in the said device for processing DICOM files comprise editing steps of:
(a) confirming whether a file is a DICOM header to identify whether the file is a DICOM file;
(b) reading DICOM Tag to acquire DICOM image according to definition of DICOM tag model from DICOM 3.0 standard;
(c) writing the DICOM header and acquiring the said patients' information and the information of the said DICOM tag to integrate with users' written reports into reports and the said DICOM tag; and
(d) repackaging DICOM files to save to database A through synchronizing database B.

8. The system of claim 1, wherein the said remote control is a personal computer, a notebook, a personal digital assistant (PDA), or a cell phone.

9. The system of claim 1, wherein the PACS is picture archiving and communication systems (PACS).

10. The system of claim 1, wherein database A is a MySQL database.

11. The system of claim 1, wherein database B is a Microsoft SQL database.

12. The system of claim 1, wherein database C is a mobile database.
